(19) United States
(12) Patent Application Publication
(10) Pub. No.: US 2016/0140760 A1
(43) Pub. Date: May 19, 2016

(54) ADAPTING A DISPLAY ON A TRANSPARENT ELECTRONIC DISPLAY

(71) Applicants: Upton Beall Bowden, Canton, MI (US); Dale O. Cramer, Royal Oak, MI (US); David Christopher Round, Saline, MI (US); Yanina Goncharenko, Wixom, MI (US)

(72) Inventors: Upton Beall Bowden, Canton, MI (US); Dale O. Cramer, Royal Oak, MI (US); David Christopher Round, Saline, MI (US); Yanina Goncharenko, Wixom, MI (US)

(21) Appl. No.: 14/540,785

(22) Filed: Nov. 13, 2014

(51) Int. Cl. G06T 19/00; B60R 1/00

(52) U.S. Cl. CPC G06T 19/006; B60R 1/00; B60R 2300/20

(57) ABSTRACT

A system and method for adapting a display on a transparent electronic display with a virtual display are disclosed herein. In one example, the system includes a focal point selector to select a focal point of the virtual display, the transparent electronic display is integrated into a front window of a vehicle. In another example, the system includes a an image detector to detect an image of an object based on a window defined by the transparent electronic display, the image detector receiving an image of the window from a front facing camera; an object augmentor to augment the object, and the transparent electronic display is integrated into a front window of a vehicle, and the object augmentor augments the object based on a distance of the object away from the vehicle and a speed of the vehicle.

### BACKGROUND

Electronic systems employ a display to convey information. In certain cases, the display may be implemented in a specific context, such as cockpit of a vehicle. Often times the display is engage-able, and thus may be operable by pressing the display to instigate an action.

In certain implementations, multiple displays may be employed. By spreading information over multiple displays, more information may be conveyed to an operator of the electronic system. Certain modern electronic systems allow a single electronic control unit, such as a central processor or computer to be attached to multiple display systems.

In a vehicle, several electronic displays may exist and be capable of conveying information to a driver or passenger. For example, the vehicle may have a heads-up display (HUD), a cockpit installed display, a display installed in the dashboard, displays embedded in various mirrors and other reflective surfaces, and the like.

One such implementation in which a HUD may be realized in is a windshield or a front window. The windshield (or any window in a vehicle) may be converted to a transparent display. Accordingly, the windshield may allow a driver or passenger to view outside the vehicle, while simultaneously selectively lighting portions of the windshield to display images.

Thus, a view in which a driver or passenger sees outside a window of the vehicle may be augmented. By employing image processing techniques, various objects may be detected from the exterior of the window, and lighted in a specific way. Thus, the display may be equipped with an exterior camera that allows for detection and identification of objects outside of the vehicle.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example implementation of a system for adapting a display on a transparent electronic display.

FIG. 3 illustrates an example of a method for adapting a display on a transparent electronic display.

FIG. 4 illustrates an example of a method for adjusting object detection for a transparent electronic display based on a sensed parameter associated with a vehicle.

FIG. 5 illustrates an example of one of the above described embodiments of vehicle with an electronic display implementing system shown in FIG. 2.

FIG. 6 illustrates an example of another one of the above described embodiments of vehicle with an electronic display implementing the system shown in FIG. 2.

FIGS. 7(a) and (b) illustrate an example of another one of the above described embodiments of vehicle with an electronic display implementing the system shown in FIG. 2.

FIGS. 8(a)-(c) illustrate an example of another one of the above described embodiments of vehicle with an electronic display implementing the system shown in FIG. 2.

### SUMMARY

A system and method for adapting a display on a transparent electronic display with a virtual display are disclosed herein. In one example, the system includes a focal point selector to select a focal point of the virtual display, the transparent electronic display is integrated into a front window of a vehicle. In another example, the system includes a an image detector to detect an image of an object based on a window defined by the transparent electronic display, the image detector receiving an image of the window from a front facing camera; an object augmentor to augment the object, and the transparent electronic display is integrated into a front window of a vehicle, and the object augmentor augments the object based on a distance of the object away from the vehicle and a speed of the vehicle.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Electronic displays in a vehicle are employed to convey information digitally to a driver or passenger. Traditionally, these electronic displays have been implemented in or around a dashboard area.

In recent times, the idea of placing a display as part of a window or a transparent surface has been realized. Thus, a driver or passenger may utilize the window not only as a surface to view outside the vehicle, but also to view lighted or digitized information on the surface. In these cases, the windows may be substantially transparent, with the ability to also light up selectively based on controlling electronics.

As explained in the Background section, the present implementations may be accomplished with a HUD device. These options provide a planar display that may statically provide an image. However, due to the planar and static display capabilities, the present technology may not serve an adaptive functionality based on a viewer's preference or comfort.

Disclosed herein are methods, systems, and devices for adapting a display on a transparent electronic display. Employing the aspects disclosed herein allows for an image or video electronically displayed onto the transparent electronic surface to change based on at least one of the parameters discussed herein. For example, the parameters may be associated with the speed of the vehicle, a user's preference, or the like.

The adjustment to the display may be one of several adjustments discussed herein. In one example, the adjustment may be a highlighted portion, or augmented element on the transparent display based on the speed of the vehicle. In another example, the focal point of the transparent display may change based on the speed or one of the other parameters discussed herein.

Thus, employing the aspects disclosed herein, a transparent display (such as a HUD) may be delivered to a consumer that not only is more user friendly and pleasing to the eye, but also safer and beneficial to operating a vehicle.

The aspects disclosed herein are described in the context of vehicle implementation, and specifically an automobile. However, one of ordinary skill in the art may appreciate the concepts disclosed herein may also be applied to any situation in which an electronic transparent display is provided with the disclosed parameters.

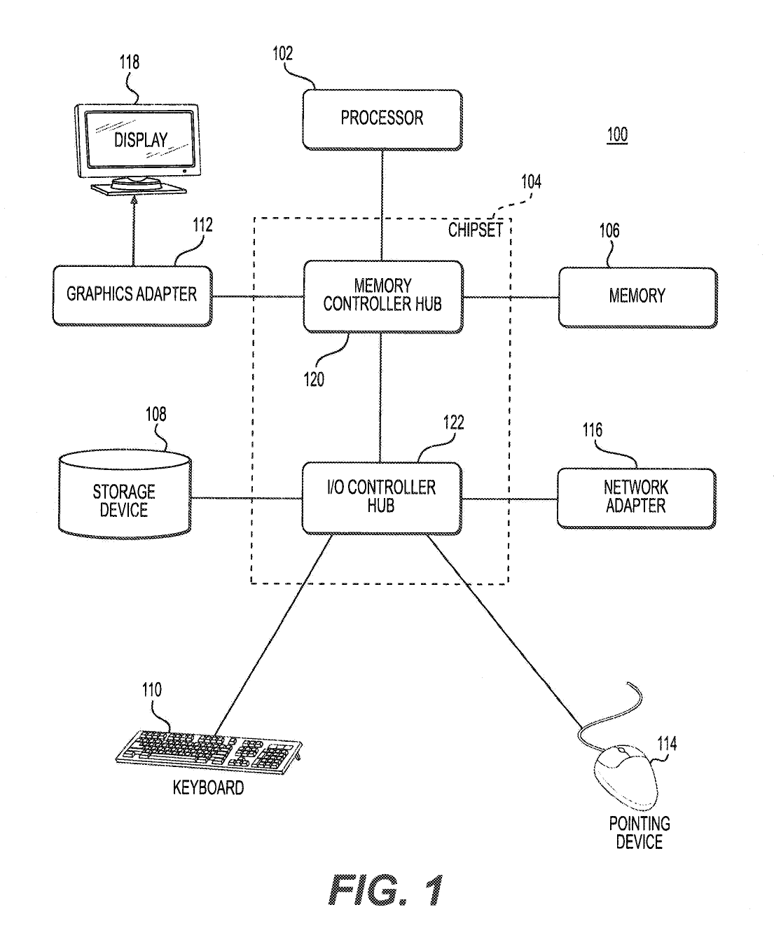

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network.

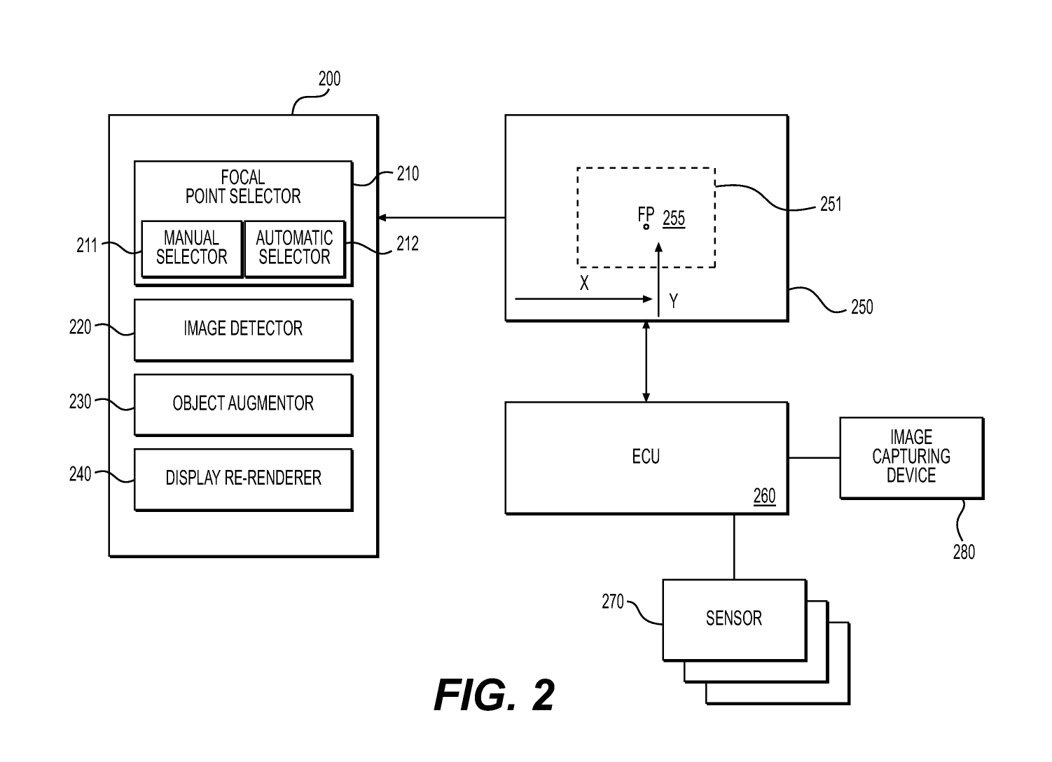

FIG. 2 illustrates an example implementation of a system 200 for adapting a display on a transparent electronic display 250. The system 200 includes a focal point selector 210, an image detector 220, an object augmentor 230, and a display re-renderer 240. The system 200 may be incorporated with some or all of the componentry discussed above with regards to computer 100. An implementation of system 200 described below may include all of the elements shown, or certain elements may be selectively provided or incorporated.

The transparent electronic display 250 may be a HUD, such as those described above. The transparent electronic display 250 is implemented in a vehicle, and may be installed on a windshield of the vehicle. Several examples of this implementation will be described below. In one example, the transparent electronic display 250 may be integrated with the windshield of the vehicle.

System 200 communicates to/from the electronic display 250 via a wired/wireless connection. The information and images displayed on the electronic display 250 may be sourced from a persistent store (i.e. any of the storage devices enumerated above), and rendered on the electronic display 250 via a driving circuit, such as those known to one of ordinary skill in the art. The system 200 may communicate with a secondary system, such as an electronic control unit (ECU) 260, and receive various stimuli and signals associated with information to render. The ECU 260 may communicate with various sensors of a vehicle (not shown), and render information onto the display 250. For example, the sensors 270 may relate to the speed, the operation, or information from an image capturing device 280 (i.e. a video camera or image camera), or the like.

The ECU 260 may communicate to the electronic display 250, and render the images that are displayed on the electronic display 250. Additionally, the system 200 may alter and contribute to the images being displayed via the electronic display 250.

The focal point selector 210 may include various elements to adjust the focal point 255 (focal point 255). The focal point 255 refers to an X and Y location in which a window 251 is displayed on the electronic display 250. The window 251 is adjustable based on the focal point selector 210. The window 251 is a virtual display that may be lightened and projected on various portions of the electronic display 250. The size and location may be adjusted according to the aspects disclosed herein.

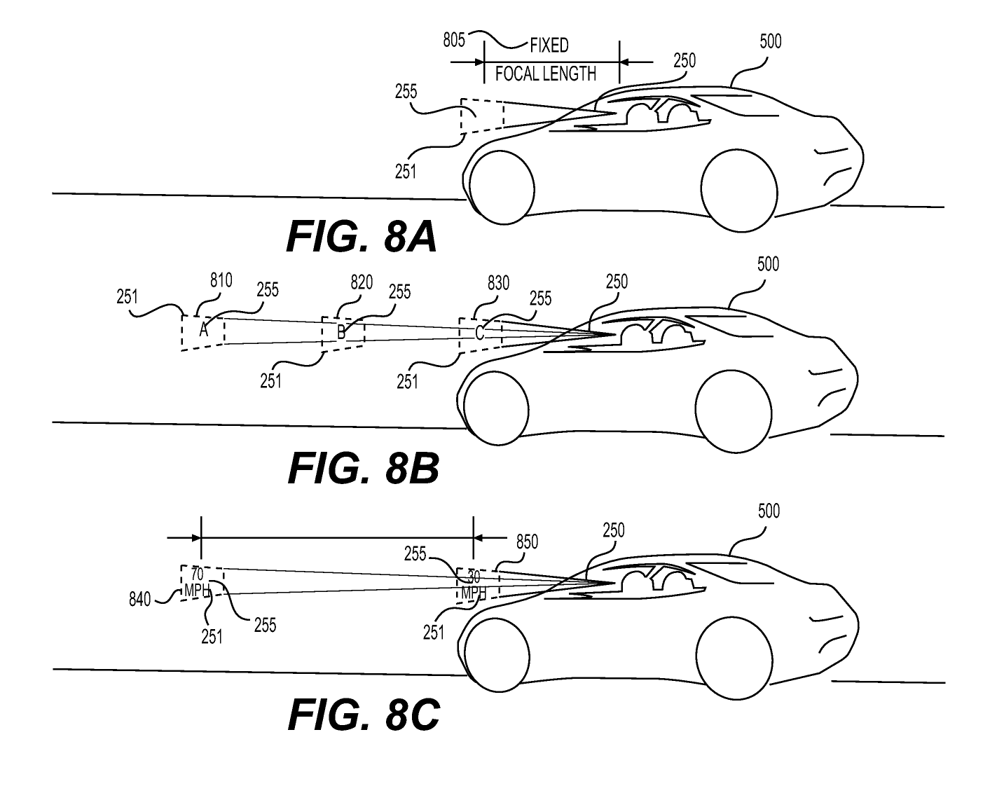

The focal point selector 210 may include a manual selector 211 and an automatic selector 212. The manual selector 211 allows an operator or a system implementer to manually select an X and Y coordinate associated with the window 251. The operator may adjust the X and Y coordinate with any input device known to one of ordinary skill in the art. An example of this is shown in FIGS. 8(a)-(c).

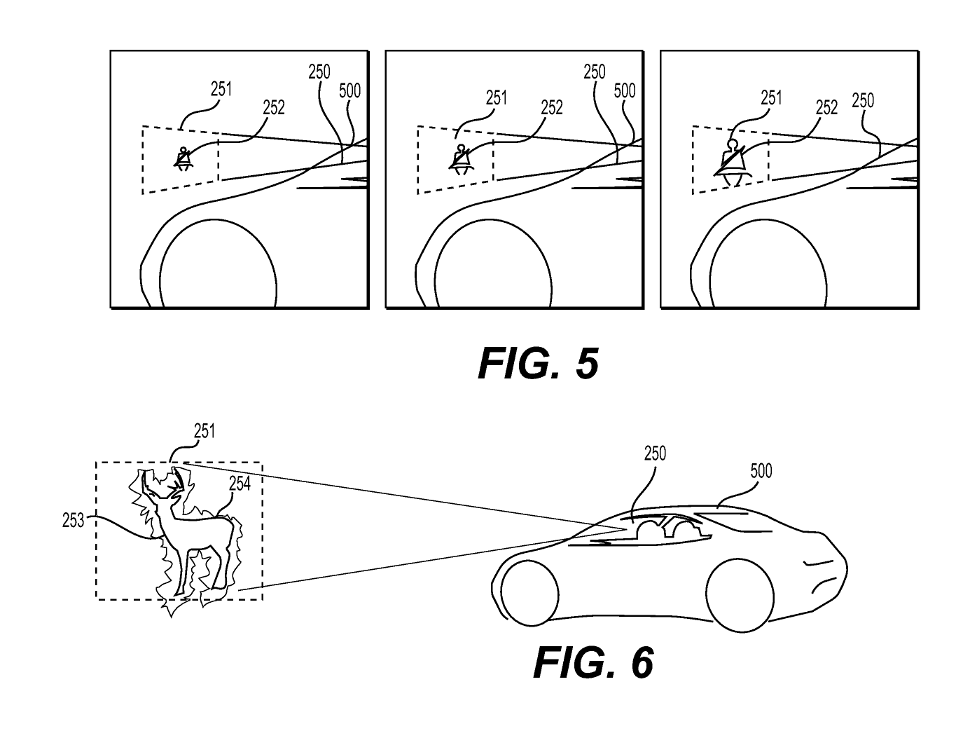

In addition to the X and Y coordinate associated with window 251, the operator associated with display 250 may select a zoom amount. An example of this is shown in FIG. 5.

The automatic focal point selector 212 may employ a sensed parameter associated with the vehicular operation to determine the focal point. For example, the speed of the vehicle may be communicated (via the ECU 260), and employed to determine a location of window 251. For example, based on the speed of the vehicle, a window 251 location may be altered with a predetermined formula. In another example, the zoom amount may also be altered by a predetermined formula relating the zoom amount to the speed of the vehicle.

The image detector 220 detects an image (or object) visible from the display 250. For example, the image capturing device 280 may record an image (or constantly be recording images), process the image, and employ digital signal processing to identify an object in front of the vehicle, and visible via the vehicle's surface in which the electronic display 250 is implemented on. The system 200 may record an instance of the image/object via a persistent store 205. For example, the image/object may be an animal or another vehicle in front of the vehicle.

An object augmentor 230 determines whether to augment the detected image/object via an external stimulus based on one of the parameters being sensed by the sensor 270. For example, if the sensor 270 is monitoring the speed of the vehicle, the augmentation may be speed based. The implementer of system 200 may determine that at a predetermined speed, the image/object is to be augmented. A rationale for providing this is that if the vehicle is travelling at a speedier rate, images that are farther apart may warrant extra highlighting or augmentation.

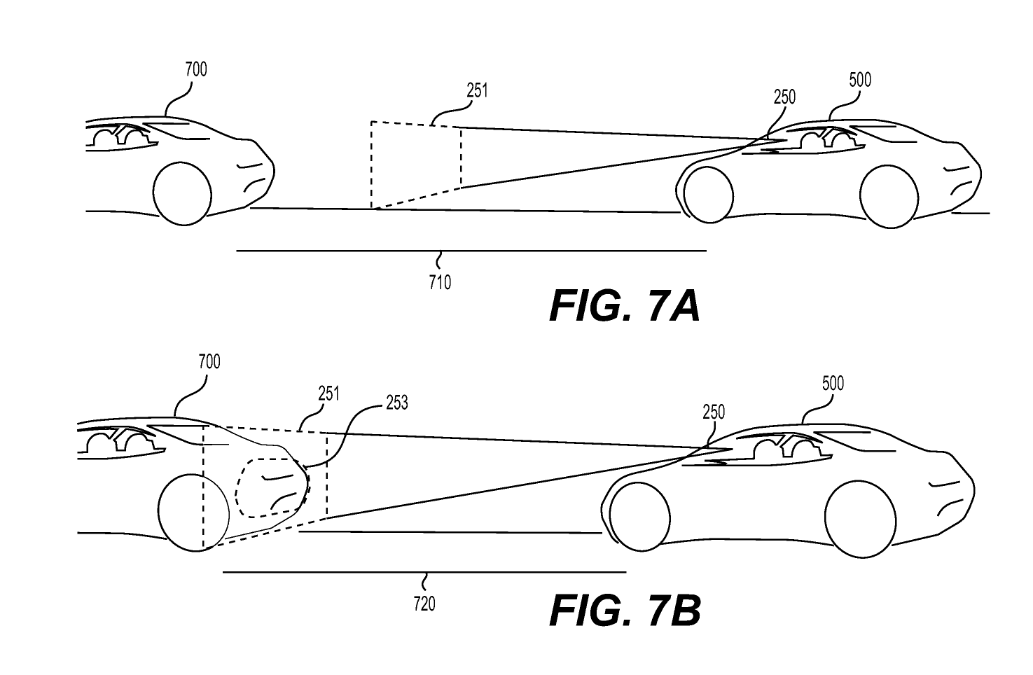

The augmentation may be performed via several different techniques. In one example, as shown below in FIG. 6, an object (i.e. an animal in the line of sight) is highlighted. In another example, as shown in FIG. 7, an upcoming vehicle is shown as being within an alert zone based on the speed and distance.

The display re-renderer 240 renders the display based on the adjustments performed and calculated by the elements of system 200. Accordingly, the electronic display 250 may be adjusted based on the speed of the vehicle, a user adjustment, or based on any parameters sensed by a sensor attached to an ECU 260.

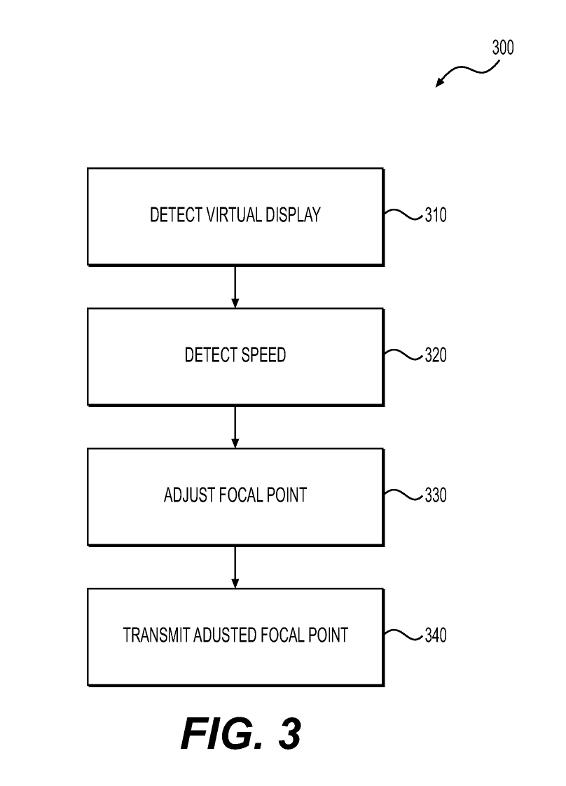

FIG. 3 illustrates an example of a method 300 for adapting a display on a transparent electronic display 250. The method 300 may be performed on a processor, such as computer 100 described above.

In operation 310, a virtual display on a transparent electronic display is detected. As explained above, the virtual display may be any sort of portion on a transparent electronic display employed to project and display information, while allowing a view to observe items beyond the virtual display.

In operation 320, a speed associated with an environment in which the HUD is installed is detected. For example, the transparent electronic display may be installed in a vehicle. Thus, as the vehicle is accelerated or de-accelerated, the speed may be detected by a speed sensor and recorded in operation 320.

In operation 330, the focal point associated with the virtual display is adjusted. The focal point may be adjusted due to the detected speed. Certain speeds may be correlated to a certain focal point, and the focal point may be adjusted accordingly. Based on the speed of the vehicle, a user's focal point associated with a virtual display may be changed or optimized.

In operation 340, the adjusted focal point is transmitted to an electronic display for adjustment. Operations 310-340 may change every time a speed is changed, or re-determined at predetermined intervals.

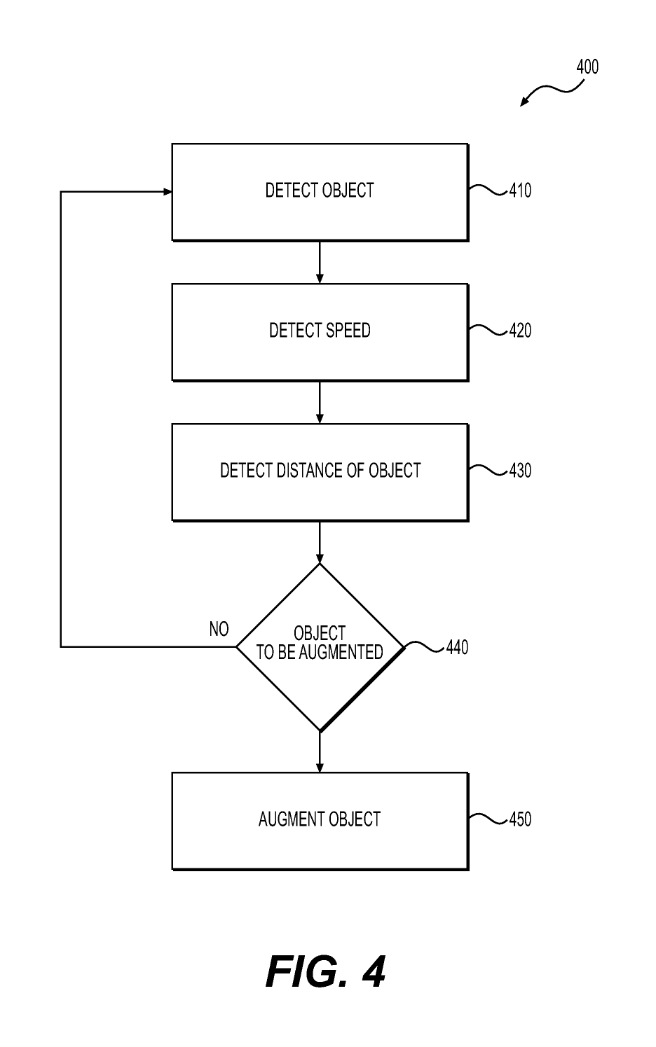

FIG. 4 illustrates an example of a method 400 for adjusting object detection for a HUD based on a sensed parameter associated with a vehicle. The method 400 may be performed on a processor, such as computer 100.

In operation 410, an object in front of a vehicle's window (for example, a windshield) is detected. The object may be detected by an image capturing device associated with the vehicle or HUD implementation. As shown in FIGS. 6 and 7, the object may be a foreign object (such as an animal), or another vehicle on the road.

In operation 420, a speed of the vehicle is detected. As explained above, the speed may indicate how soon the vehicle may approach or hit the object. In operation 430, the distance of the object from the vehicle is detected. The distance of the object may be ascertained from known techniques associated with distance estimation based on digital signal processing.

In operation 440, a determination to augment the object made. The determination may be based on a correlation with the detected speed of the vehicle and distance of the object being within a predetermined threshold amount.

In operation 450, if the determination to augment the object is made, the object is augmented. In one example, the object is highlighted, for example provided with a glow or halo. In another example, the vehicle may be instructed to alert the passenger via an audio indicating device installed or implemented in the vehicle.

FIG. 5 illustrates an example of one of the above described embodiments of vehicle 500 with an electronic display 250 implementing system 200. As shown, the electronic display 250 includes a window 251 (a virtual display). For illustrative purposes, the window 251 is shown away from the vehicle 500. However, the window 251 in an operating condition would appear to be displayed on the front window of the vehicle 500.

As shown in FIG. 5, the three different depictions shows an indicia 252 being displayed. In the example in FIG. 5, the indicia 252 refers to a signal indicating that a driver or passenger is not wearing a seatbelt. However, in another example, any sort of graphics or icons known to one of ordinary skill in the art may be placed for indicia 252. The size of the indicia 252 may also be based on a the speed of the vehicle 500.

In each case, the indicia 252 is made smaller or larger based on an operator of vehicle 500's preference. In one embodiment, the indicia 252's size may be determined by a user preference. In another embodiment, the speed of the vehicle 500 may be correlated to a specific size of the indicia 252.

FIG. 6 illustrates an example of another one of the above described embodiments of vehicle 500 with an electronic display 250 implementing system 200.

Referring to FIG. 6, once again a window 251 is shown (virtual display). An object 254 is in front of the vehicle 500. If the detected object 254 is within a specific distance, and if the vehicle is travelling above a specific speed, the object 254 may be augmented with indicia 253. Indicia 253 may be a glow or halo around object 254. As explained above, the augmentation may occur in another way, for example, alerting the driver of vehicle 500 to a notice that an object 254 is in front of the vehicle 254. The indicia 253 may be drawn on the electronic display (i.e. HUD) on the front window of the vehicle 250.

FIGS. 7(a) and (b) illustrate an example of another one of the above described embodiments of vehicle 500 with an electronic display 250 implementing system 200.

Referring to FIGS. 7(a) and (b), a vehicle 500 is on the same road as a vehicle 700. Referring to FIG. 7(a), the vehicle 500 and vehicle 700 are a distance 710 apart from each other. Referring to FIG. 7(b), the vehicle 500 and vehicle 700 are a distance 720 apart from each other.

In FIG. 7(a), the distance 710 is beyond a predetermined threshold, and thus, the window 251 does not indicate any sort of indication that an object is within or in front of the vehicle 500.

However, in FIG. 7(b), the distance 720 is within the predetermined threshold, and thus, an augmentation 253 is shown. This allows the driver or passenger of vehicle 500 to be alerted that a vehicle 700 in front of the vehicle 500 may be close relative to a safe operating distance.

In another example, the predetermined threshold may be established and modified based on the speed of vehicle 500. Thus, if vehicle 500 is travelling at a relatively faster speed, the decision to provide augmentation 253 may occur at a distance 710 or 720 further away (relative to a slower speed).

FIGS. 8(a)-(c) illustrate an example of another one of the above described embodiments of vehicle 500 with an electronic display 250 implementing system 200.

In FIG. 8(a), the vehicle 500 has a fixed focal length 805. Thus, the window 251 appears at the same location on the HUD (electronic display 250) regardless of the operation of the vehicle 500 or any sort of user manipulation.

In FIG. 8(b), the vehicle 500 shows three distinct focal points 255 (810, 820, 830). Essentially, the focal point 255 is determined by the driver or passenger of the vehicle 500.

In FIG. 8(c), the vehicle 500 has a first focal point 840 and second focal point 850. The shown focal point 255 is determined based on the speed the vehicle 500 is operating at. In each case, the focal point 255 allows the driver or passenger to focus at a specific point away from the vehicle based on the speed of the car. For example, when the vehicle 500 is travelling 70 miles per hour (MPH), the focal point 255 (840) is further away. When the vehicle 500 is travelling 30 MPH (850), the focal point 255 allows the window 251 to be at a near location to the vehicle 500. Thus, the focal point 255 is configured to be placed at a location to optimize where the driver or passenger is looking at.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for adapting a display on a transparent electronic display with a virtual display, comprising:
a focal point selector to select a focal point of the virtual display;
a display re-renderer to communicate the selected focal point to the transparent electronic display,
wherein the transparent electronic display is integrated into a front window of a vehicle.

2. The system according to claim 1, wherein the focal point selector further comprises a manual selector configured to receive a manual selection of the selected focal point.

3. The system according to claim 1, further comprising an automatic selector to select the focal point based on a predefined relationship.

4. The system according to claim 3, wherein the predefined relationship is based on a speed of the vehicle.

5. The system according to claim 4, further comprising an image detector to detect an image corresponding to a captured.

6. The system according to claim 5, wherein the vehicle's operation is at least one of a speed of the vehicle, a light associated with the vehicle's operation, a check engine light, and a RPM of the vehicle.

7. A system for adapting a display on a transparent electronic display with a virtual display, comprising:
an image detector to detect an image of an object based on a window defined by the transparent electronic display, the image detector receiving an image of the window from a front facing camera;
an object augmentor to augment the object; and
a display re-renderer to transmit information about the augmentation to the transparent display,
wherein the transparent electronic display is integrated into a front window of a vehicle, and
the object augmentor augments the object based on a distance of the object away from the vehicle and a speed of the vehicle.

8. The system according to claim 7, wherein the object augmentor augments the image of the object by highlighting the image of the object.

9. The system according to claim 7, wherein the object augmentor augments the image by instructing the vehicle to alert a sound.

10. The system according to claim 7, wherein the object is another vehicle.

11. A method for adapting a display on a transparent electronic display with a virtual display, comprising:
integrating the transparent electronic display onto a front window of a vehicle; and
re-rendering the virtual display based on a sensed parameter associated with an operation of the vehicle,
wherein the integrating and the re-rendering are performed on a processor.

12. The method according to claim 11, wherein the re-rendering is performed by adjusting a focal point of the virtual display.

13. The method according to claim 12, wherein the adjusting is based on an automatic process based on a sensor associated with the vehicle.

14. The method according to claim 13, wherein the sensor is a speedometer of the vehicle.

15. The method according to claim 12, wherein the adjusting is based on a manual operation by an operator associated with the transparent electronic display.

16. The method according to claim 12, wherein the adjusting is based on a manual operation by an operator associated with the transparent electronic display.

17. The method according to claim 13, wherein the re-rendering of the virtual display is at least one of an enlargement or minimization of indicia within the virtual display.

18. The method according to claim 11, further comprising receiving an image of an object as seen by an operator via the virtual display, and augmenting the image based on a condition.

19. The method according to claim 18, wherein the condition is a distance the object is away from the vehicle.

20. The method according to claim 18, wherein the condition is a speed of the vehicle.
